(19) United States
(12) Patent Application Publication
(10) Pub. No.: US 2006/0020073 A1
(43) Pub. Date: Jan. 26, 2006

(54) Process and compositions for making optical fiber gels

(76) Inventors: Saurabh S. Lawate, Concord, OH (US); Robert A. Silverstein, Great Neck, NY (US); John C. Tolfa, Midland, MI (US)

Correspondence Address: The Lubrizol Corporation;Patent Dept./Mail Drop 022B, 29400 Lakeland Blvd., Wickliffe, OH, 44092-2298, US

(21) Appl. No.: 10/509,350

(22) PCT Filed: Mar. 25, 2003
(86) PCT No.: PCT/US03/08912

§ 371 Date: Aug. 5, 2005

Related U.S. Application Data
(60) Provisional application No. 60/369,008, filed on Apr. 1, 2002.

(51) Int. Cl. C08K 3/34

(52) U.S. Cl. 524/492

(57) ABSTRACT

A process of forming a gel for gel packed transmission cable comprising the steps of dissolving a high molecular weight polymer in oil and thereafter through the use of a rotor and stator mixer effectively incorporating a colloidal silica(s) into the polymer in oil composition. Compositions made from this process having optimized viscosity are also claimed.

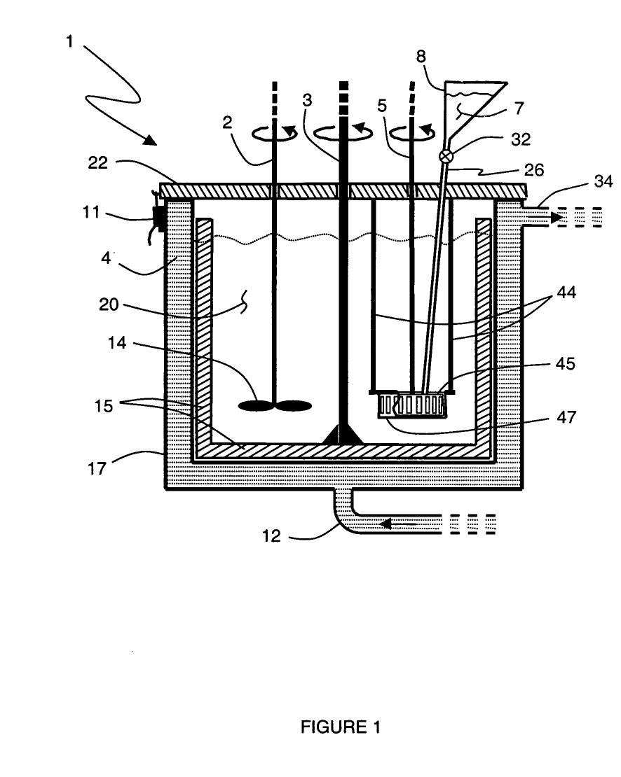

### FIELD OF INVENTION

The invention relates to gels including colloidal particles used as greases in filled cable compounds, general greases, and field responsive fluids (electro-rheological). The gels in filled cables minimize the intrusion of water and other harmful compounds into filled information transmission cables such as optical fiber cables. The gels along with the cable sheath protect the internal wires, fibers etc. from stresses applied to the cables sheath.

### BACKGROUND OF THE INVENTION

Typically optical fiber cables, which are mainly used by the communications industry, contain a bundle of glass fibers encased in a polymeric sheathing. During manufacture a non-aqueous jelly like substance (optical fiber gel) is introduced in the spacing between the fibers and the polymeric sheathing. The function of the gel is to provide shock absorption, provide protection to the fiber from bending and twisting stress and provide water repellency. The gel fills the interstices and also prevents entry of water ingression from other mechanisms such as ingress when the water vapor pressure outside the cable is greater than inside the cable.

A variety of configurations of optical fibers bunched together within the polymeric sheathing exist. Also, a variety of polymeric sheathing materials are used such as polypropylene, polyethylene. The optical fiber gel must meet certain performance specifications defined by an OEM (original equipment manufacturer, of the optical fiber cable). Typically the gels are thixotropic as this facilitates cable filling and prevents some low stress migration later in cable use. Typical specifications include viscosity, yield stress, oxidative stability, low temperature performance and compatibility with the polymer sheathing. Product consistency with respect to specifications is critical for an optical fiber gel.

U.S. Pat. No. 4,701,016 summarizes many of the aspects of manufacturing both gels with appropriate properties for fiber optic cables and fiber optic cables.

### SUMMARY OF THE INVENTION

A critical feature in manufacturing gels for fiber optic cables and the fiber optic cables is batch-to-batch uniformity in the physical properties of the gels. Typically the colloidal material is difficult to disperse uniformly as small particles and forms aggregates of colloidal material that are difficult to subsequently disperse. The quality of the colloidal material dispersion dramatically affects the various moduli of the gel, as aggregates of colloidal material do not have the same viscosity modifying effect as dispersed particles. Similarly the high molecular weight polymers have a disproportionate effect based on their weight percent on the viscosity of the oil and consequently the gel modulus. The resulting gels typically are thixotropic having a critical yield stress above which the material flows and below which it is generally rigid.

A process is disclosed of using a rotor and stator mixer in combination with more conventional mixing blades (such as a slow speed anchor blade in combination with a high shear emulsifier blade) to form a sequential composition of consistent viscosity and low batch-to-batch variation. Also disclosed are optimized compositions for gels for fiber optic cables derived from oil, colloidal silica filler, a high molecular weight polymer and optional functional additives. Gel compositions were developed based on various basestocks and thickeners, which are compatible with conventional polymeric sheathings (e.g. they do not soften or deteriorate the sheath material).

### BRIEF DESCRIPTION OF THE DRAWINGS

The attached FIGURE illustrates a desirable configuration for the mixing equipment for the preferred embodiment.

### DETAILED DESCRIPTION OF THE INVENTION

The gel composition generally comprises a base oil, a high molecular weight polymer, a colloidal silica, and optionally coupling agents and additives such as antioxidants, antiwear agents, antifoam, and hydrogen absorbing agents.

Base Oil

The base oil can be any of the American Petroleum Institute's (API) Group I, Group II, Group III, Group IV, or Group V basestock. Typical base oils include mineral oils, hydrotreated mineral oils, PAOs, vegetable oils and synthetic esters. Specific examples of this type of component include hydrocracked mineral oils, poly (alpha olefin), vegetable oils and other synthetic oils such as esters, glycols and polybutene.

The amounts of base oil in the compositions of the present invention are generally from about 80 to about 96 weight percent, more desirably from about 86 to about 95 and more preferably from about 88 to about 93 weight percent.

High Molecular Weight Polymer

The high molecular weight polymer can be selected from a variety of known oil soluble polymers above 1000 number average molecular weight as determined by gel permeation chromatography using polystyrene standards. The high molecular weight polymer needs to have solubility at 20° C. in a SAE 5 mineral oil of at least 50 grams per liter. These polymers can be various homopolymer and copolymers (including block copolymers) of styrene, conjugated dienes (e.g. butadiene), alpha olefins etc. including repeat units from other less oil soluble monomers in smaller amounts that do not result in insufficient oil solubility of the resulting polymer. Block copolymers are particularly preferred for bleed resistant gels. Specific examples of this type of component include Kraton from Shell Chemical and Ketjenlube from Akzo Nobel as well as equivalent products from other manufacturers. Preferably the amount of high molecular weight polymer is from about 3 to about 10 weight percent, more desirably from about 3 to about 8, and preferably from about 3 to about 5 weight percent.

The high molecular weight polymer provides a particular viscosity modification to the gel. The polymer swells with the oil and if adjacent polymer molecules touch each other or interpenetrate each other, they contribute significantly higher viscosity to the gel. If the polymers interpenetrate they have a tendency to want to return back to their original position after being deformed, as is well known to the art. This is called elastic memory and can be desirable or undesirable, depending on a variety of factors. Viscosity modification with high molecular weight polymers tends to be less sensitive to temperature changes than particulate viscosity modification and thus is used to minimize or prevent bleeding of oil from the gel at higher use or installation temperatures.

Colloidal Particulate e.g. Colloidal Silica

Colloidal hydrophobic and hydrophilic silica used individually or in combination. The colloidal particulate can be hydrophobic and or hydrophilic fumed silica or other particles such as iron and other inorganic particulate materials. Specific examples of this type of component include Aerosil and Cabosil silicas from DeGussa and Cabot corporations. The amounts of colloidal particulate in the compositions of the present invention are desirably from about 1 to 50 weight percent, more desirably from about 2 to 10 weight percent, and preferably from about 4 to about 8 weight percent.

The colloidal particulate provides a particular type of viscosity modification to the gel not available from high molecular weight soluble polymers. When sufficient colloidal material is present, the surfaces of adjacent particulate materials can hydrogen bond to adjacent particles forming a network that is resistant to stress. This provides thixotropic behavior, high yield stress values, and bleed reistance (anti-drip). Above a certain stress value these hydrogen bonds are broken and the gel deforms without memory of its previous shape and the hydrogen bonds between adjacent particles reform to re-establish a rigid network.

Coupling Agent(s)

Coupling agents are optional and function to couple the particulate material into a more continuous network building viscosity or modulus without adding more particulate material. Coupling agents generally are capable of hydrogen bonding with hydroxyl groups on the colloidal particulate material. Coupling agents with hydroxyl groups are preferred (e.g. monofunctional and polyfunctional alcohols. They can be monomeric, oligomeric, or polymeric. Specific examples of this type of component include polyglycols (including but not limited to poly (alkylene oxide) and other polyols.

The amounts of coupling agents are generally up to 2 or 5 weight percent, more desirably from about 0.1 to about 2, and preferably from about 0.1 to about 0.5, and preferably from about 0.1 to about 0.3 weight percent.

Other Optional Additives Such as Antioxidants, Antiwear Additives, Extreme Pressure Additives (EP), Antifoam, and Hydrogen Absorbing Agents.

Other additives include antioxidants, hydrogen absorbing agents, surfactants, antiwear (including EP) agents, and antifoam agents. These may or may not be necessary depending upon the particular application of the gel and transmission cable. The antioxidants help increase oxidative induction time, ameliorate changes in the molecular weight of the oil and high molecular weight polymer, and reduce adverse color changes in the gel. Without them, depending on the resistance of the oil and polymer to oxidation, the oil and polymer might degrade into lower molecular weight components (possibly volatile), or higher molecular weight components (possibly sludge), and or a combination of lower and higher molecular weights (generating both more volatility and more sludge). The antifoam agents would help reduce the inclusion of gas bubbles in the gel and reduce foaming above the surface of the gel.

The amounts of optional functional components in the compositions of the present invention are generally up to 5 weight percent, more desirably from about 0.1 to about 1, and preferably from about 0.1 to about 0.5 weight percent.

The particular relationship between the amounts and types of the above components is by weight.

Equipment

The attached figure shows features of the equipment for the preferred embodiment. The equipment is labeled 1. An shaft 2 for the optional high speed emulsifier/dispersator 14 is mounted so that it does not collide with shaft 3 of a low speed anchor (e.g. planetary) mixer 15. A jacketed mixing tank 17 is used to contain the gel 20 (contents of the mixing tank) and control the mix temperature through a temperature control fluid 4. A shaft 5 to the rotor is mounted near the additive addition area. An liquid or solid additive 7 is stored in a reservoir 8 for said additive and can be added to the rotor 46 stator 47 mixer via the valve 32 to control addition of liquid or solid additives and the tube 26 to add the same near the suction side of the rotor and stator. A hasp 11 is used to secure the lid 22 of the mixing tank to the tank. The mixing tank has a fluid inlet 12 and exit 34. The stator is shown with two arms 44 to hold it in a fixed position relative to the rotating rotor.

The Process

The composition described above is preferably prepared using the process set forth below and a mixer with at least a rotor and stator mixer, optionally equipped with a vacuum or tube delivery system (SLIM system from Ross) for the colloidal particulate that results in the colloidal particulate being added below the surface of the components to the gel and desirably directly into a flow of gel into the rotor and stator mixer. It is also desirable to have an inert gas (such as N₂) input and in the headspace of the mixer and a heating/cooling jacket at least partially contacting the mixing surface. Such a mixer is available from Ross and is called a Versamix. The Ross Versamix has a low speed anchor type mixer to keep the contents of the batch stirred, a higher speed emulsifier capable of forming emulsions, and a rotor and stator mixer capable of dispersing and in some cases fracturing particles.

A preferred method is to use a mixer, which has three mixing blades: planetary anchor blade, high-speed disperser (Cowles blade), and rotor-stator which can be separately controlled and/or operated simultaneously in one mixing tank. A jacketed mixing tank further enhances the system as it allows temperature control (e.g. heating to help dissolve the high molecular weight polymer and cooling to bring the temperature of the components or gel down before adding the antioxidant. A suction device built into the rotor-stator disperser is a further enhancement which enables incorporation of solids (e.g. colloidal particulate silica) into the mixing tank immediately before the rotor and stator where effective dispersing can be achieved in the first few seconds after the colloidal particulate is added to the components.

Using this mixer a typical process for manufacturing of optical fiber gels according to the following examples is:
1. Mix the base oil with a high molecular weight polymer and heat the mixture to 120-132° C. for at least one hour. Use all three blades for 5-10 minutes after which only the anchor blade is used. Check sample to ensure that all solid materials appear to have been incorporated and dispersed.
2. Cool mixture to about 60° C. and add the antioxidant and other optional functional additives and stir for at least five minutes to assure reasonable dispersion within the oil.
3. Charge the silica through the vacuum suction device. Run all three blades at high speed for at least 20 minutes. Temperature is maintained at about 49° C. but increases to 65° C. due to heat of mixing.
4. Add coupler and mix using all three blades for at least 30 minutes with the temperature of at least 49° C.
5. Cool to about 38° C. and deaerate mixture using a vacuum pump.

6. Transfer mixture out of mixing tank using a platen press or a positive displacement pump.

Recipe I: Synthetic Oil Based Recipe

| Ingredient | Manufacturer | Quantity | Wt. Percent |
|---|---|---|---|
| PAO-8 (base oil) | BP-Amoco | 61.987 | 88.5 |
| Kraton 1701 (polymer) | Shell Chemical | 3.419 | 4.9 |
| Irganox L135 (antioxidant) | Ciba | 0.199 | 0.3 |
| Aerosil 974 - Hydrophobic | Degussa | 2.907 | 4.2 |
| Silica | | | |
| Aerosil 300VS - Hydrophilic | Degussa | 1.211 | 1.7 |
| Silica | | | |
| Polyglycol 2000 (coupling | Dow Chemical | 0.285 | 0.4 |
| agent) | | | |
| Total | | 70.01 | 100 |

Recipe II: Mineral Oil Based Recipe

| Ingredient | Manufacturer | Quantity | Wt. Percent |
|---|---|---|---|
| Conoco 70N (base oil) | Conoco | 62.0 | 88.6 |
| Kraton 1701 (polymer) | Shell Chemical | 6.13 | 8.8 |
| Irganox L135 (antioxidant) | Ciba | 0.197 | 0.3 |
| Aerosil 300VS - Hydrophilic | Degussa | 1.404 | 2.0 |
| Silica | | | |
| Polyglycol 2000 (coupling | Dow Chemical | 0.285 | 0.4 |
| agent) | | | |
| Total | | 70.02 | 100.1 |

[image]

The process used with the triple mixer configuration yields a homogenous, well dispersed product. Product is used at an optical fiber gel as a buffer for shocks and as a water repellent

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

Each of the documents referred to above is incorporated herein by reference. Except in the Examples, or where otherwise explicitly indicated, all numerical quantities in this description specifying amounts of materials, reaction conditions, molecular weights, number of carbon atoms, and the like, are to be understood as modified by the word “about.” Unless otherwise indicated, each chemical or composition referred to herein should be interpreted as being a commercial grade material which may contain the isomers, by-products, derivatives, and other such materials which are normally understood to be present in the commercial grade. However, the amount of each chemical component is presented exclusive of any solvent or diluent oil, which may be customarily present in the commercial material, unless otherwise indicated. It is to be understood that the upper and lower amount, range, and ratio limits set forth herein may be independently combined. While ranges are given for most of the elements of the invention independent of the ranges for other elements, it is anticipated that in more preferred embodiments of the invention, the elements of the invention are to be combined with the various (assorted) desired or preferred ranges for each element of the invention in various combinations.

As used herein, the expression “consisting essentially of” permits the inclusion of substances that do not materially affect the basic and novel characteristics of the composition under consideration. Comprising means having at least the listed elements and optionally a variety of other unnamed elements that might affect the basic characteristics of the composition.

What is claimed is:

1. A process of manufacturing a gel comprising;
a) dissolving a high molecular weight polymer in an oil using stirring and a temperature above 60° C. forming a blend,
b) cooling the blend below 60° C. and adding with mixing one or more antioxidants forming a stabilized blend,
c) adding at least one type of colloidal particle (e.g.silica) to said stabilized blend using at least a rotor and stator mixer and one other mixer forming a thixotropic blend,
d) optionally deaerating said thixotropic blend
e) cooling said thixotropic blend.

2. A process according to claim 1 wherein said rotor and stator mixer is also used to disperse said high molecular weight polymer in step a.

3. A process according to claim 1, wherein an anchor mixer is used to agitate said blend(s) along with the use of said rotor and stator mixer.

4. A process according to claim 3, also using an emulsifying mixer other than said rotor and stator mixer.

5. A process according to claim 3, wherein said blend of oil and high molecular weight polymer are heated to at least 80° C. for 30 minutes to dissolve the high molecular weight polymer.

6. A process according to claim 3, wherein a suction device or tube (e.g. built into the rotor and stator) directs the colloidal silica to an area near the inlet (feed area) of the rotor and stator mixer.

7. A gel composition comprising:
a) a high molecular weight polymer in an oil,
b) one or more antioxidants, and
c) at least one type of colloidal particle (e.g.silica).

8. A gel composition according to claim 7, wherein said gel is made by a processing of dissolving said high molecular weight polymer in oil using stirring, cooling that product below 60° C. and adding an antioxidant, and adding colloidal particles using rotor and stator mixing to increase the viscosity of the blend of oil, high molecular weight polymer and antioxidant.
